(19) United States
(12) Patent Application Publication
(10) Pub. No.: US 2011/0234604 A1
(43) Pub. Date: Sep. 29, 2011

(54) ELECTRONIC PAPER DISPLAY AND METHOD FOR BOOTING UP ELECTRONIC PAPER DISPLAY

(75) Inventors: KUAN-HONG HSIEH, Tu-Cheng (TW); HAN-CHE WANG, Tu-Cheng (TW); WAN-JUN JIANG, Shenzhen City (CN)

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/882,157

(22) Filed: Sep. 14, 2010

(30) Foreign Application Priority Data
Mar. 26, 2010 (CN) 201010133461.8

(51) Int. Cl. G06F 13/14

(52) U.S. Cl. 345/520

(57) ABSTRACT

An Electronic Paper Display (EPD) includes a central processing unit (CPU), an EPD screen, a first storage storing applications, an EPD controller. The EPD controller is configured for running the stored software applications and controlling the EPD screen to display visual information. The EPD further includes a second storage and a temporary controller. The second storage is configured for storing files capable of being displayed on the EPD screen during the process of booting up the EPD. The temporary controller is configured for determining whether the process of initializing the CPU is finished during the process of booting up the EPD, and further configured for starting the EPD controller, copying the files from the second storage, and delivering the files to the EPD controller to display if the process of initializing the CPU is not finished.

### BACKGROUND

1. Technical Field

The present disclosure relates to displays and, particularly, to an Electronic Paper Display (EPD) and a method for booting up the EPD.

2. Description of the Related Art

Commonly, during boot up of EPDs, users cannot view any on-screen interfaces or input any information, and users may become impatient waiting through boot up.

Therefore, there is room for improvement within the art.

### BRIEF DESCRIPTION OF THE DRAWINGS

The components in the drawings are not necessarily drawn to scale, the emphasis instead being placed upon clearly illustrating the principles of an EPD and a method for booting up the EPD. Moreover, in the drawings, like reference numerals designate corresponding parts throughout the several views.

FIG. 1 is a block diagram of an EPD in accordance with an exemplary embodiment.

FIG. 2 is a flowchart of a method for booting up the EPD of FIG. 1 in accordance with an exemplary embodiment.

### DETAILED DESCRIPTION

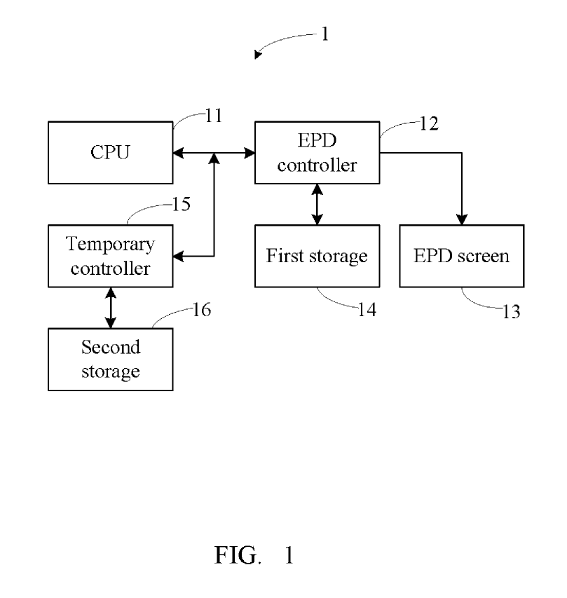

Referring to FIG. 1, an EPD 1 includes a central processing unit (CPU) 11, an EPD controller 12, an EPD screen 13, and a first storage 14. The first storage 14 stores software applications, such as office software, operable by the EPD 1. The EPD controller 12 is configured to run the software applications and control the EPD screen 13 to display visual information.

The EPD 1 further includes a temporary controller 15 and a second storage 16. The temporary controller 15 is connected between the CPU 11 and the EPD controller 12. The second storage 16 is connected to the temporary controller 15. The second storage 16 is configured to store files which can be displayed on the EPD screen 13 during the process of booting up the EPD 1. The files stored in the second storage 16 can be provided by users or copied from the first storage 14. For example, the files stored in the second storage 16 may include images.

When the EPD 1 is powered on, the temporary controller 15 is started and determines whether the process of initializing the CPU 11 has finished. If yes, the temporary controller 15 stops working, and the CPU 11 controls the EPD controller 12 to run the software applications stored in the first storage 14 and controls the EPD screen 13 to display visual information.

If the CPU 11 has not initialized yet, the temporary controller 15 starts the EPD controller 12, copies the files from the second storage 16, and delivers the files to the EPD controller 12. The EPD controller 12 controls the EPD screen 13 to display the files. Therefore, during the process of booting up the EPD 1, the EPD 1 is capable of providing an available interface on the EPD screen 13, thus providing some functionality to the users without incurring user boredom or impatience.

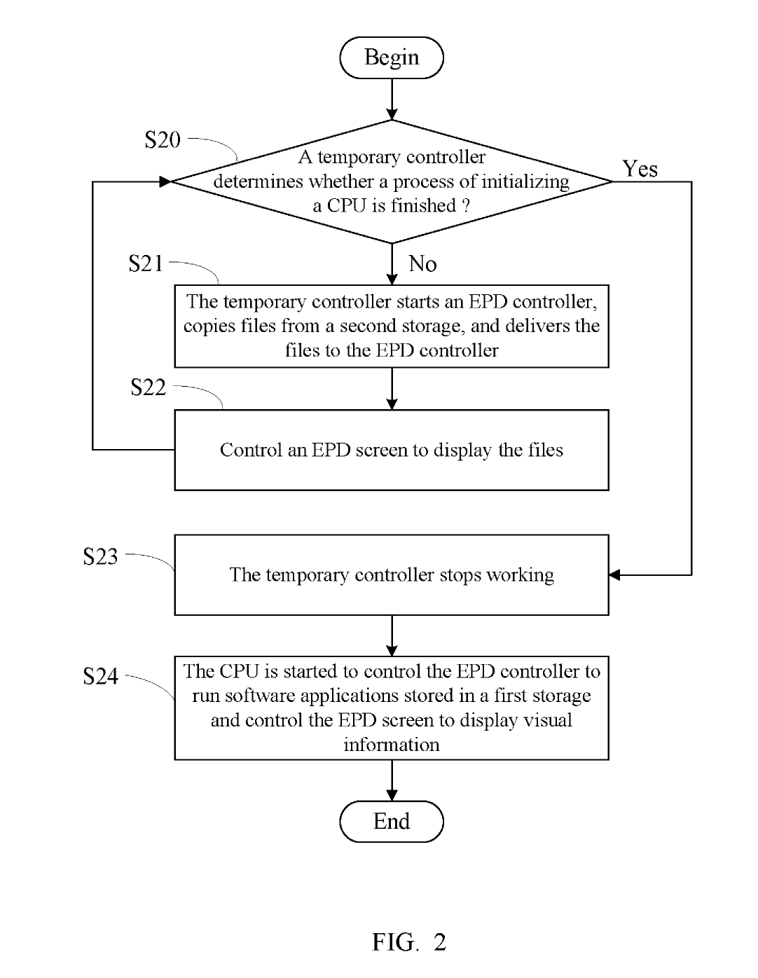

Referring to FIG. 2, a flowchart of a method for booting up the EPD of FIG. 1 in accordance with an exemplary embodiment.

In step S20, when the EPD 1 is powered on, the temporary controller 15 determines whether the process of initializing the CPU 11 is finished. If yes, the process goes to step S23, otherwise, the process goes to S21.

In step S21, during the process of initializing the CPU 11, the temporary controller 15 starts the EPD controller 12, copies the files from the second storage 17, and delivers the files to the EPD controller 12.

In this embodiment, the second storage 16 stores files which can be displayed on the EPD screen 14 during the process of booting up the EPD 1. The files stored in the second storage 16 can be provided by users or copied from the first storage 15. For example, the files stored in the second storage 16 may include images.

In step S22, the EPD controller 12 controls the EPD screen 13 to display the files, and the process goes to S20.

In step S23, if the process of initializing the CPU 12 is finished, the temporary controller 15 stops working, and the CPU 11 is started to control the EPD controller 12 to run the software applications stored in the first storage 14 and controls the EPD screen 13 to display visual information.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An Electronic Paper Display (EPD), comprising:
a central processing unit (CPU);
an EPD screen;
a first storage storing software applications;
an EPD controller, configured for running the software applications and controlling the EPD screen to display visual information;
a second storage storing files capable of being displayed on the EPD screen during a process of booting up the EPD;
a temporary controller configured for determining whether a process of initializing the CPU is finished during the process of booting up the EPD, and further configured for starting the EPD controller, copying the files from the second storage, and delivering the files to the EPD controller to display if the process of initializing the CPU is not finished.

2. The Electronic Paper Display device as recited in claim 1, wherein the files stored in the second storage are provided by users or copied from the first storage.

3. The Electronic Paper Display device as recited in claim 1, wherein when the process of initializing the CPU is finished, the temporary controller stops working, and the CPU is started to control the EPD controller to run the software applications stored in the first storage and controls the EPD screen to display visual information.

4. A method for booting up an Electronic Paper Display (EPD), the EPD comprising a central processing unit (CPU), an EPD controller, a temporary controller, an EPD screen, a first storage, and a second storage, the first storage storing applications, the second storage storing files capable of being displayed on the EPD screen during a process of booting up the EPD, the method comprising:
powering on the EPD;
during a process of initializing the CPU, the temporary controller starting the EPD controller, copying files from the second storage, and delivering the files to the EPD controller; and
controlling the EPD screen to display the files.

5. The method as recited in claim 4, the method further comprising:
the temporary controller determining whether the process of initializing the CPU is finished, and stopping working when the process of initializing the CPU is finished; and
the CPU controlling the EPD controller to run the software applications stored in the first storage and controls the EPD screen to display visual information.

6. The method as recited in claim 4, the files stored in the second storage are provided by users or copied from the first storage.
